(19) United States
(12) Patent Application Publication
(10) Pub. No.: US 2023/0039243 A1
(43) Pub. Date: Feb. 9, 2023

(54) PRISM SHEET AND LIGHTING DEVICE USING THE SAME

(71) Applicant: Japan Display Inc., Tokyo (JP)

(72) Inventors: Makoto HASEGAWA, Tokyo (JP); Nobuyuki SUZUKI, Tokyo (JP)

(73) Assignee: Japan Display Inc., Tokyo (JP)

(21) Appl. No.: 17/963,223

(22) Filed: Oct. 11, 2022

Related U.S. Application Data
(63) Continuation of application No. PCT/JP2021/003742, filed on Feb. 2, 2021.

(30) Foreign Application Priority Data
Apr. 15, 2020 (JP) 2020-072757

(51) Int. Cl. F21V 8/00

(52) U.S. Cl. CPC G02B 6/0053

(57) ABSTRACT

A purpose of the present invention is to realize a prism sheet in which an outer shape is circular and has a concentric prism array. The present invention includes the structure: A prism sheet has a circular outer shape and a concentric prism array on one surface, in which groove is formed in radial direction from a center of the concentric prism array so as to cross the concentric prism array. The air entrained in the prism array during manufacturing is exhausted through the groove.

### CROSS-REFERENCE TO RELATED APPLICATIONS

The present application is a continuation application of International Application No. PCT/JP2021/003742, filed on Feb. 2, 2021, which claims priority to Japanese Patent Application No. 2020-072757, filed Apr. 15, 2020. The contents of these applications are incorporated herein by reference in their entirety.

### BACKGROUND OF THE INVENTION

### (1) Field of the Invention

The present invention relates to a prism sheet having a circular outer shape and a concentric prism array, and a lighting device using the same.

### (2) Description of the Related Art

Light emitting diodes (LEDs) are being used for the lighting device. Light emitting diodes have high luminous efficiency, and thus profitable for low power consumption. The light emitting diode, however, is a point light source; it must be transformed to the surface light source if it is used as a lighting device. On the other hand, a prism sheet can be used to decrease a light emitting angle.

Patent document 1 discloses a lighting device having a flat emitting surface, in which the light emitted from the LED, disposed on the side wall of the lighting device, is reflected at the reflective back surface having a certain angle to the flat emitting surface, and is mitted from the emitting surface.

Patent document 2 discloses a prism sheet whose outer shape is rectangle, in which a radial prism array is formed on one side, and a concentric prism array is formed on another side.

Patent document 3 discloses a prism sheet whose outer shape is rectangle, in which a linear prism array is formed and a surface in the valleys between the linear prisms is made coarse to suppress a formation of a side robe.

### DOCUMENTS OF TECHNICAL PRIOR ART

### Patent Document

Patent document 1: WO 2013-080903
Patent document 2: Japanese patent application laid open No. 2006-91821
Patent document 3: Japanese patent application laid open No. 2012-68370

### SUMMARY OF THE INVENTION

The lighting device needs to have a small light distribution angle when it is used as e.g. a spot light. Conventionally, for such a lighting device, a parabolic mirror has been used to form a parallel light. However, a certain depth is necessary in such a lighting device; therefore, it is difficult to attain a small lighting device or a thin lighting device.

On the other hand, the emitting light can be aligned in a normal direction of the emitting surface by using a fine pitch prism array. In other words, it is possible to decrease a light distribution angle by using a prism sheet. When the emitting surface is made circular, a circular prism sheet is desirable to adapt the emitting surface. Manufacturing of the circular prism sheet, however, has a different problem from manufacturing the conventional rectangle prism sheet.

The purpose of the present invention is to enable manufacturing a circular prism sheet and, consequently, to realize a lighting device of thin and being able to emit collimated light.

The present invention solves the above explained problems; concrete structures are as follows.

(1) A prism sheet having a circular outer shape and a concentric prism array on one surface, in which a groove is formed in radial direction from a center of the concentric prism array as to cross the concentric prism array.

(2) A prism sheet having a circular outer shape and a concentric prism array on one surface, in which each of circular prisms which constitutes the concentric prism array has a discontinuous part in circumferential direction.

(3) A prism sheet having a circular outer shape including: a semicircular first prism sheet and a semicircular second prism sheet, in which a first prism array which has a plurality of concentric semicircular array is formed on one surface of the first prism sheet, a second prism array which has another plurality of concentric semicircular array is formed on one surface of the second prism sheet, and the first prism sheet and the second prism sheet are disposed with a predetermined distance therebetween.

(4) Another surface of each of the prism sheet of (1), (2) and (3) is plane.

(5) A lighting device which uses one of the prism sheets of (1) to (4).

(6) The lighting device which uses the prism sheet of (4), in which the other surface, which is plane, of the prism sheet is disposed in a side of an emitting surface.

(7) The lighting device according to (1) to (4), in which either one of the prism sheets of (1) to (4) is disposed on a circler light guide.

### BRIEF DESCRIPTION OF THE DRAWINGS

FIG. 1 is a perspective view of a lighting device;

FIG. 2 is a definition of the light distribution angle;

FIG. 3 is a plan view of the lighting device, which collimates light with parabolic mirror;

FIG. 4 is a cross sectional view of FIG. 3 along the line A-A;

FIG. 5 is a plan view of the lighting device

FIG. 6 is a cross sectional view of FIG. 5 along the line B-B;

FIG. 7 is an exploded perspective view of the lighting device;

FIG. 8 is a cross sectional view of FIG. 7 along the line C-C, which is a cross sectional view at the vicinity of an axis of a frame;

FIG. 9 is a plan view in which a first light guide and a second light guide overlap;

FIG. 10A is a plan view of the first light guide;

FIG. 10B is a cross sectional view of FIG. 10A along the line D-D;

FIG. 10C is a cross sectional view of FIG. 10A along the line E-E;

FIG. 11A is a plan view of a prism sheet;

FIG. 11B is a cross sectional view of FIG. 10A along the line F-F;

FIG. 12 is a cross sectional view of a manufacturing device of a prism sheet;

FIG. 13 is a plan view in which a prism array whose outer shape is rectangle is being formed on a sheet;

FIG. 14 is a plan view in which entrained air is being exhausted through an air path from the prism array of FIG. 13;

FIG. 15 is a plan view in which a prism array whose outer shape is circular is being formed on a sheet;

FIG. 16 is a plan view in which a problem in manufacturing the prism array whose outer shape is circular;

FIG. 17A is a plan view of embodiment 1;

FIG. 17B is a cross sectional view of FIG. 17A along the line G-G;

FIG. 17C is another cross sectional view of FIG. 17A along the line G-G;

FIG. 18A is a plan view of embodiment 2;

FIG. 18B is a cross sectional view of FIG. 18A along the line H-H;

FIG. 18C is another cross sectional view of FIG. 18A along the line H-H;

FIG. 19A is a plan view of embodiment 3;

FIG. 19B is a cross sectional view of FIG. 19A along the line I-I; and

FIG. 20 is a plan view of another example of a prism sheet.

### DETAILED DESCRIPTION OF THE PREFERRED EMBODIMENTS

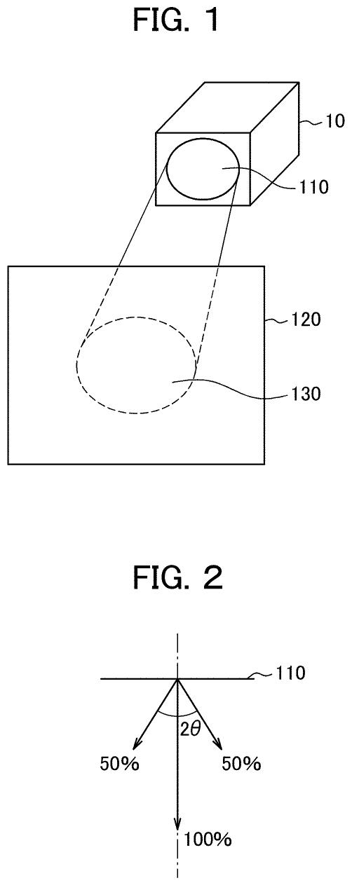

FIG. 1 is an example of a lighting device 10, which is used for a spot light. The light from the lighting device 10 is collimated; a spot light 130 is emitted from an emitting surface 110, and applied to an incident surface 120. The light distribution angle is controlled as e.g. 12 degrees to acquire the spot light 130.

FIG. 2 defines the light distribution angle. FIG. 2 shows e.g. that a spot light is applied to the floor from the light emitting surface 110 disposed on the ceiling. The light intensity is largest at the normal direction to the light emitting surface 110; the light intensity decreases according to the polar angle becoming larger. The light distribution angle is defined as 2θ provided the intensity along the normal direction is 100%, and the intensity along the polar angle θ is 50%. In normally collimated light, the light distribution angle is required as 12 degrees or less.

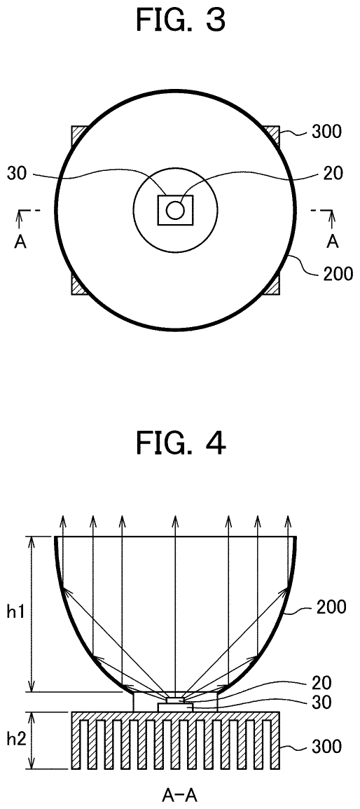

Conventionally, a parabolic mirror 200 has been used to acquire such a collimated light. FIG. 3 is a plan view of the lighting device using the parabolic mirror 200; FIG. 4 is a cross sectional view of the lighting device of FIG. 3. In FIG. 3, an LED 20 is set at the center of the parabolic mirror 200. The LED 20 is set e.g. on a PCB substrate 30. The LED 20 is a high brightness LED, which becomes high temperature; thus, the LED 20 is set on a heat sink 300. A part of the heat sink 300, which is set at the rear of the parabolic mirror 200, is visible in FIG. 3.

FIG. 4 is a cross sectional view of FIG. 3 along the line A-A. In FIG. 4, the LED 20 is disposed at the bottom surface of the parabolic mirror 200. The lights emitted from the LED 20, except the light emitted in the optical axis direction, reflect at the parabolic mirror 200 and become parallel to the optical axis. The parabolic mirror 200, however, needs to be as high as h1 for enough collimating function. The height h1 of the parabolic mirror 200 needs to be about 60 mm to acquire the light distribution angle of about 12 degrees. Actually, since the height h2 of the heat sink 300, approximately 20 mm for example, is added, the total height of the lighting device becomes 80 mm or more. In the meantime, in the lighting device of FIGS. 3 and 4, one LED, which constitutes the light source, needs to be supplied with a large power; consequently, the heat generation in the LED becomes large, thus, the heat sink is indispensable.

The purpose of the present invention is to realize a lighting device, which can emit collimated light, of thin and comparatively low power consumption. In addition, the purpose of the present invention is to enable to manufacture a prism sheet which is adapted to such a lighting device. The present invention is explained by the following embodiments.

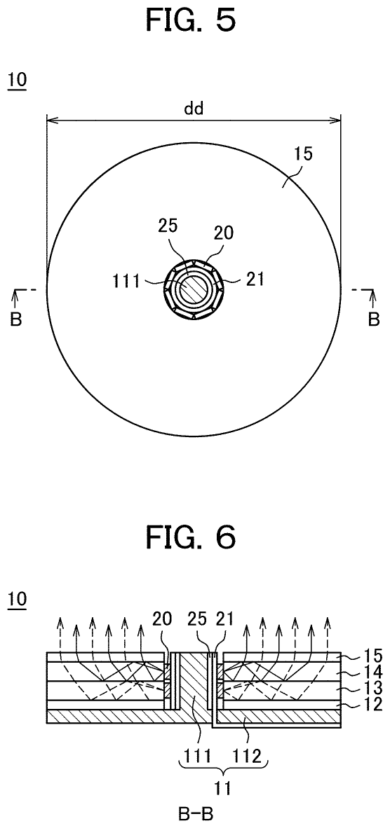

FIG. 5 is a plan view depicting an example of the lighting device 10 to which the present invention is applied; FIG. 6 is a cross sectional view of FIG. 5 along the line B-B. As depicted in FIG. 5, a plan view of the lighting device is circular; and a prism sheet 15 is disposed at the upper most surface of the lighting device. Each of the optical components is disc shaped, and is inserted in an axis 111 of the metal frame 11, which has a central axis 111 and a circular flange 112. A flexible wiring substrate 21, on which LEDs are installed, is disposed to surround the axis 111 of the frame 11; the flexible wiring substrate 21 is adhered to the axis 111 of the frame 11 through a heat conductive sheet 25. The heat generated by the LED 20 conducts to the axis 111 of the frame 11 through the heat conductive sheet 25, and is dissipated into the flange 112 of the frame 11. An outer size dd of the lighting device 10 is e.g. 98 mm.

FIG. 6 is a cross sectional view of FIG. 5 along the line B-B. In FIG. 6, a reflecting sheet 12, a bottom light guide 13, a top light guide 14, and the prism sheet 15 are superposed in this order on the flange 112 of the frame 11 formed from metal. Each of those optical components has a hole at the center to be adapted to the axis 111 of the frame 11. The flexible wiring substrate 21, on which LEDs 20 are installed, is adhered surrounding the axis 111 of the frame 11. A part of the flexible wiring substrates 21 extends to back of the flange 112 of the frame 11 through a cut out formed in the flange 112 of the frame 11. The flexible wiring substrate 21 and the axis 111 of the frame 11 are adhered to each other by the heat conductive tape 25, which has a superior heat conductivity.

In FIG. 6, the arrows are examples of light passes of the light entered the light guides 13 and 14 from the LEDs 20. The arrows of broken lines are light passes of the light entered the bottom light guide form the bottom LEDs; the arrows of solid lines are light passes of the light entered the top light guide form the top LEDs. The light entered the top light guide 14 and the bottom light guide 13 repeats reflections at interfaces of the light guides and the reflection sheets, and eventually goes in upper direction, namely, in a direction of the emitting surface. In the structure of FIG. 6, the light also reflects at the interface between the top light guide 14 and the bottom light guide 13, therefore, the light is directed to the emitting surface more efficiently than that of a case when there is only one light guide.

In FIG. 6, the light emitted from the major surface of the top light guide 14 is further collimated by the prism sheet 15, disposed on the top light guide 14, to be aligned in a normal direction of the emitting surface of the lighting device 10. A prism array is formed on the circular prism sheet concentrically.

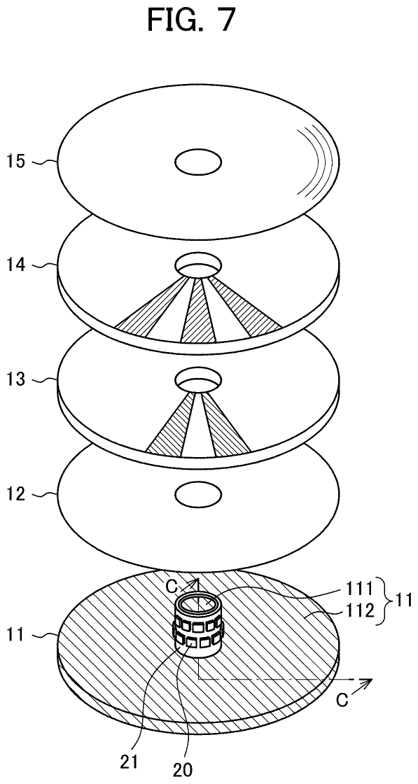

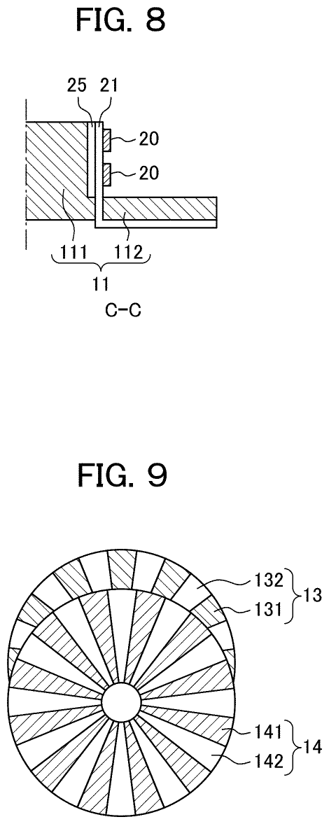

FIG. 7 is an exploded perspective view of the structure of the lighting device explained in FIG. 6. The flexible wiring substrate 21, installed with LEDs 20, surrounds and is adhered to the axis 111 of the frame 11 through the heat conductive tape 25. FIG. 8 is a cross sectional view of FIG. 7 along the line C-C, which is a detailed cross sectional view at the vicinity of the axis 111 of the frame 11. The LEDs 20 are disposed in two tiers on the flexible wiring substrate 21, and are disposed to oppose to the top light guide 14 and the bottom light guide 13. The LED 20 becomes high temperature, however, the heat of the LED 20 is dissipated to the axis 111 of the frame 11, which is made of metal, through the thin flexible wiring substrate 21 and the flexible wiring substrate 25 that has a superior heat conductivity.

Back to FIG. 7, the axis 111 of the frame 11 is inserted in the holes of the reflection sheet 12, bottom light guide 13, the top light guide 14, and the prism sheet 15. FIG. 9 is a plan view of the top light guide 14 and the bottom light guide 13. The pattern area 131 and 141, in which prism arrays are formed, and no pattern area 132 and 142, in which prism patterns are not formed, are formed in each of the bottom light guide 13 and the top light guide 14.

When the bottom light guide 13 and the top light guide 14 are superposed, the pattern area 131 of the bottom light guide 13 overlaps the no pattern area 142 of the top light guide 14; and the no patter area 132 of the bottom light guide 13 overlaps the pattern area 141 of the top light guide 14.

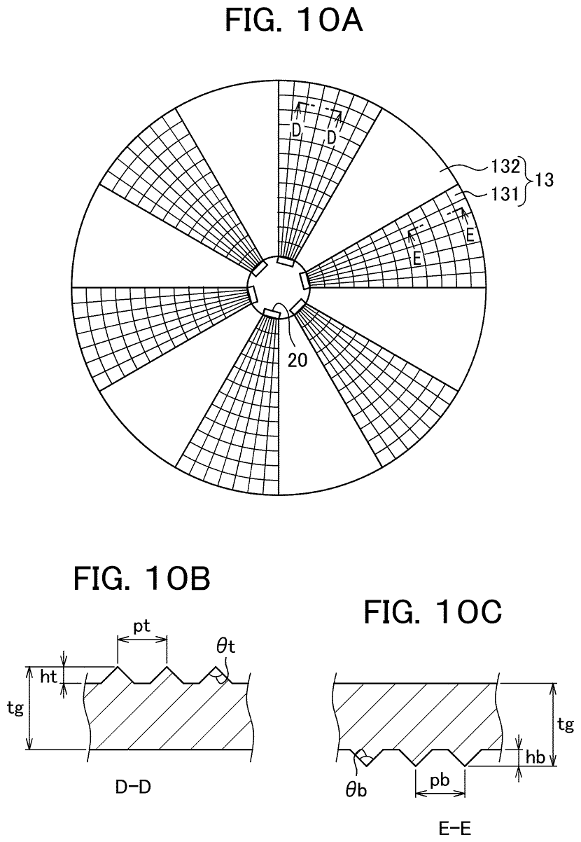

FIG. 10A is a plan view of the structure of prism array formed on the surface of bottom light guide 13. In FIG. 10A, the area 131 of prism array and an area 132 of no prism array are disposed alternatively in a circumferential direction. The prism array formed on the top surface of the bottom light guide 13 (herein after may be called as a major surface) is formed in radially in radius direction; the prism array formed on the bottom surface of the bottom light guide 13 (herein after may be called as a back surface) is formed in concentrically. The LEDs 20 are disposed at the inner wall corresponding to the region where the prism arrays are formed.

FIG. 10B is a cross sectional view of FIG. 10A along the line D-D, which is a cross sectional view of the prism array formed on a surface of the major surface of the light guide 13. The prism array of the major surface is a pattern radially extending from the center; therefore, a pitch pt of the prism array changes according to the locations. A thickness tg of the light guide 13 is e.g. 1.5 mm; a height ht of prism array is e.g. 0.1 μm; the apex angle θt is e.g. 90 degrees.

FIG. 10C is a cross sectional view of FIG. 10A along the line E-E, which is a cross sectional view of the prism array formed on the back surface of the light guide 13. The prism array of the back surface is a pattern formed in concentrically. A pitch pb of the concentric circles is e.g. 0.1 μm; a height hb of the prism is e.g. 0.02 μm; the apex angle θb is e.g. 90 degrees. A height hb of the prism formed on the bottom surface of the prism 13 is lower than a height ht of the prism formed on the top surface of the prism 13.

However, a height and a pitch of the prism array formed either of surfaces of top and bottom of the light guide 13, are much smaller compared with a height and a pitch of the prism array formed at the surface of the prism sheet 15, which is explained later. Therefore, denser prisms are formed on the major surface and the back surface of the light guide 13. In the meantime, it is explained that the prism arrays formed on light guide 13 are formed by projections, however, the prism arrays formed by V shaped grooves also can perform the same effects.

The above explanation is made for the bottom light guide 13; however, the same figure can be applied to the top light guide 14. When the bottom light guide 13 and the top light guide 14 are assembled, the bottom light guide 13 and the top light guide 14 are deviated each other in circumferential direction so that the pattern area of the top light guide 14 superposes the no pattern area of the bottom light guide 13. LEDs are disposed according to the pattern areas at the inner sides of the top light guide and the bottom light guide.

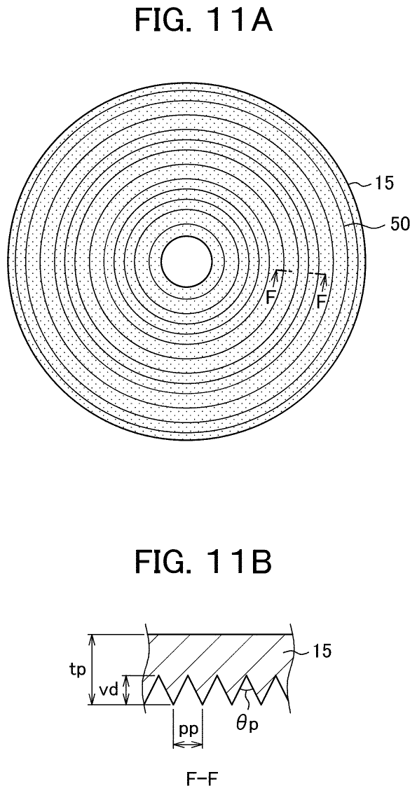

FIG. 11A is a plan view of the prism sheet 15 which is disposed on the top light guide 14. The prism sheet 15 is a so called reverse prism sheet in which the prism array 50 is formed on the surface opposing the top light guide 14. In FIG. 11A, since the prism array 50 is formed concentrically, the light all around from the top light guide 14 is collimated in a normal direction of the major surface of the prism sheet 15.

FIG. 11B is a cross sectional view of FIG. 11A along the line F-F. FIG. 11B shows that the prism array is formed at the bottom surface of the prism sheet 15. In FIG. 11B, a thickness tp of the prism sheet 15 is e.g. 200 μm, a depth vd of the V shaped groove is 75 μm, an apex angle θp is e.g. 66 degrees, a pitch pp is e.g. 100 μm. As described above, the height and the pitch formed in the prism sheet are much larger compared with the heights and the pitches of the prism arrays formed at the major surfaces and the back surfaces of the bottom light guide 13 and the top light guide 14.

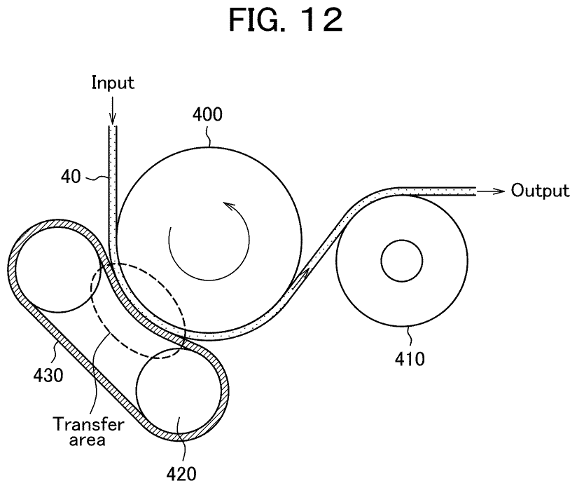

FIG. 12 is a cross sectional view of the manufacturing machine of the prism sheet. A sheet 40, which is a material of the prism sheet and made of transparent resin as acrylic, is input from the input side; the pattern of the prism array is transferred from a transfer roller 400 to the sheet 40. The sheet 40 is strongly pressed to the transfer roller 400 by a compression roller 420 and the compression belt 430 to transfer the prism pattern to the sheet 40. The sheet 40 is heated when the pattern is transferred. After the prism array is transferred, the sheet 40 is rewound by take up roller through the delivery roller 410. After that, the prism sheet 40 is cut so as to the outer shape becomes a circle.

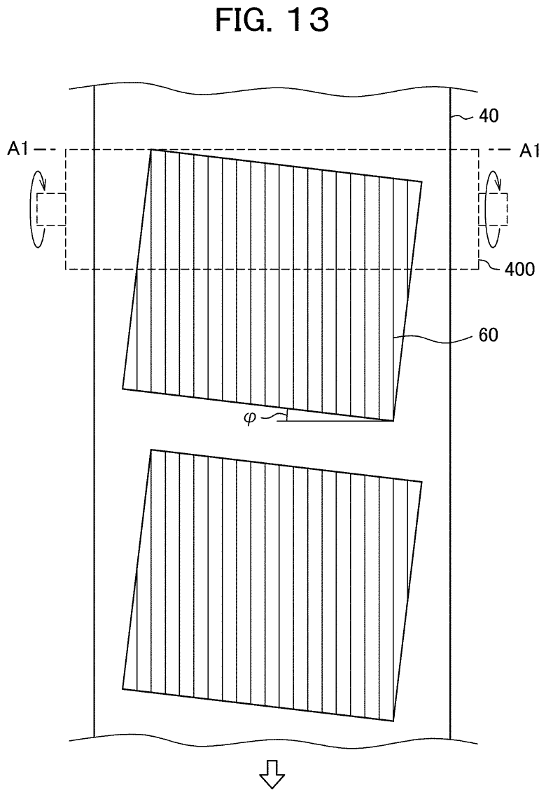

FIG. 13 is a plan view of a conventional prism sheet, having a rectangle outer shape and a linear prism array 60, is formed through the manufacturing machine of FIG. 12. In going white array direction, the prism array 60 is transferred to the sheet 40 from the transfer roller 400. In the meantime, the V groove as shown in FIG. 11B is formed in this prism array 60.

The extending direction of the prism array 60 is the same as a moving direction of the sheet 40; however, outer shape of the prism sheet tilts by φ. This is to counter measure moire when the prism sheet is installed in the product.

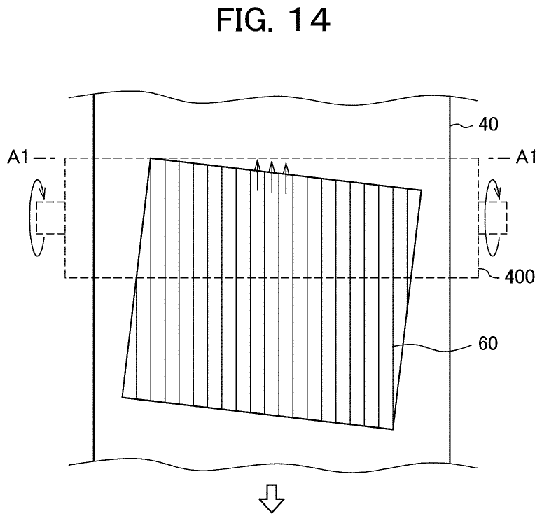

When the prism array 60 is transferred from the transfer roller 400 to the sheet 40, air is entrained between the v groove of the prism array 60 and the transfer roller 40. This air is, however, pushed to outside at the edge of the prism array 60 as depicted by arrows in FIG. 14; thus, this air does not make a problem.

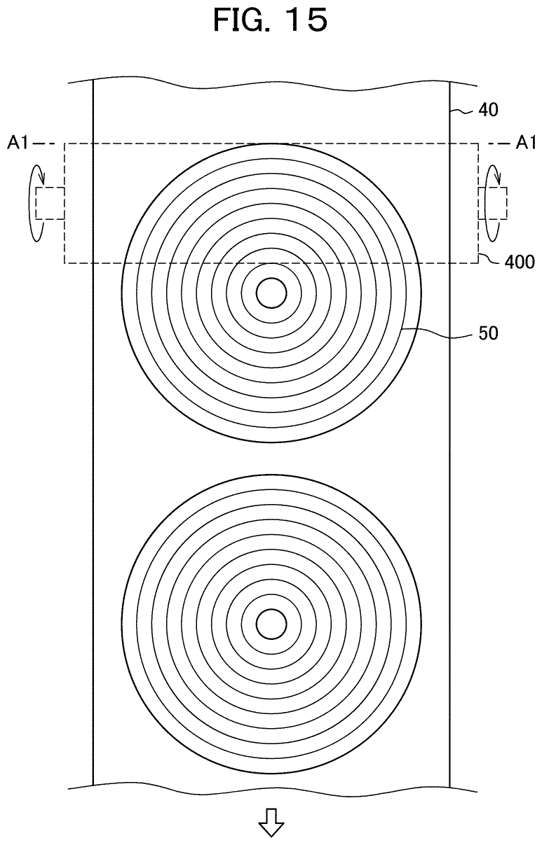

FIG. 15 is a plan view of a sheet 40 in which concentric prism array 50 is being transferred on the sheet 40 to form a circular prism sheet. FIG. 15 is a plan view, in which the upper area than the line A1-A1 is before the prism array 50 is transferred; the lower area than the line A1-A1 is after the prism array 50 is transferred to the sheet 40 through the transfer roller 400. The sheet 40 moves in bottom direction, namely, in the direction of white arrow.

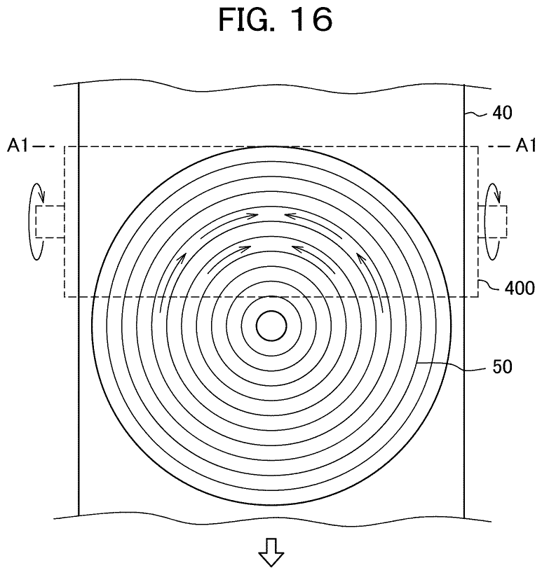

FIG. 16 is a plan view which shows a problem when the concentric prism array 50 is formed. In FIG. 16, a closed space is formed between the peak and the peak of the concentric prism array 50, namely, between the V grooves in FIG. 11B and the transfer roller 400; and air is entrained in this enclosed space. In proceeding the transfer, the air moves circumferentially along the V grooves as shown by arrows in FIG. 16. However, since this area is a closed space, the air cannot escape; therefore, a bubble is formed between the transfer roller 400 and the sheet 40; consequently, an accurate transfer cannot be formed.

The embodiments explained below overcome the above explained problem; and enable to realize a prism sheet having an accurate prism array; and thus, to realize a lighting device of high quality.

### Embodiment 1

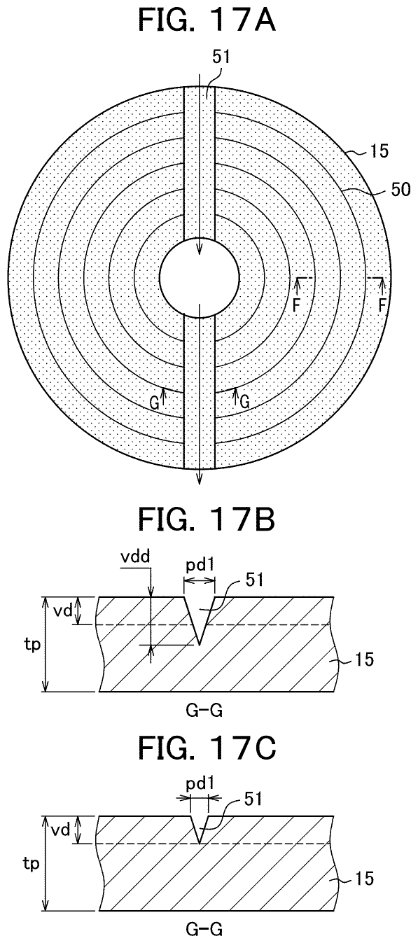

FIG. 17A is a plan view of the prism sheet 15 according to embodiment 1. In FIG. 17A, a prism array 50 is formed concentrically. A cross sectional view of the prism array 50 along the line F-F is the same as FIG. 11B. The feature of FIG. 17A is that the prism sheet 15 has an air pass groove 51 formed in radial direction of the prism array 50 for release of air. The air, entrained between the prism array 50 and the transfer roller 400, moves along the groove of the prism array 50 in circumferential direction, and is exhausted through the air path groove 51. FIG. 17A depicts this behavior by arrows. The direction of the arrows can be upward or downward. The air path groove 51 is formed also in the inner most prism and in the outer most prism.

FIG. 17B is a cross sectional view of FIG. 17A along the line G-G, namely, a cross sectional view of an air path groove 51. A depth vd indicated by broken line in FIG. 17B is a depth vd of the V groove of the prism array 50 shown in FIG. 11B. In FIG. 17B, a depth vdd of the V groove for the air path is deeper than a depth vd of the V groove of the prism array 50; the reason is to release air more easily. In addition, a width pd1 of the air path groove is preferably the same as a pitch pp of the prism array 50 or more to release air easily.

FIG. 17C is another example of a cross sectional view of FIG. 17A along the line G-G, which is another cross sectional view of an air path groove 51. In FIG. 17C, a depth of the V groove for the air path is the same as a depth vd of V groove of the prism array 50. Even this structure, a purpose of air release can be attained. The cross sectional views of the groove 51 of FIG. 17B and FIG. 17C are V shaped grooves, however, the cross section of the groove can be U shaped, rectangle, or semicircle. The air path 51 does not constitutes a prism array 50, thus, a cross section of the groove 51 can take any shape as far as it is adaptable for manufacturing.

### Embodiment 2

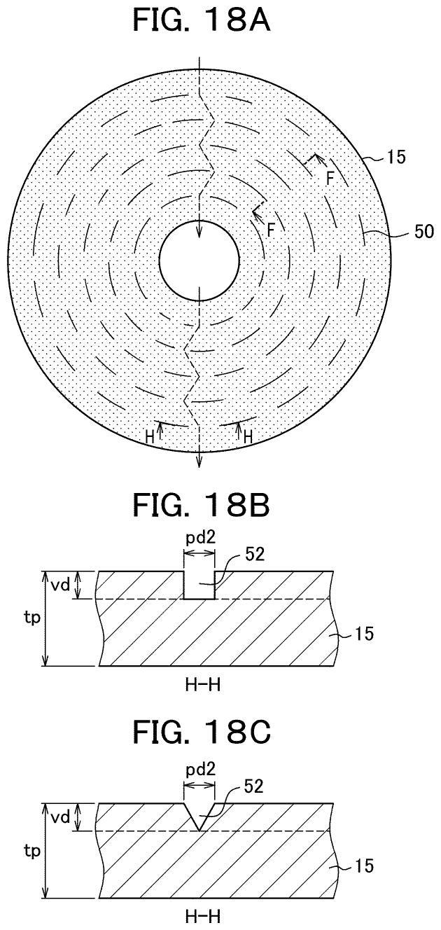

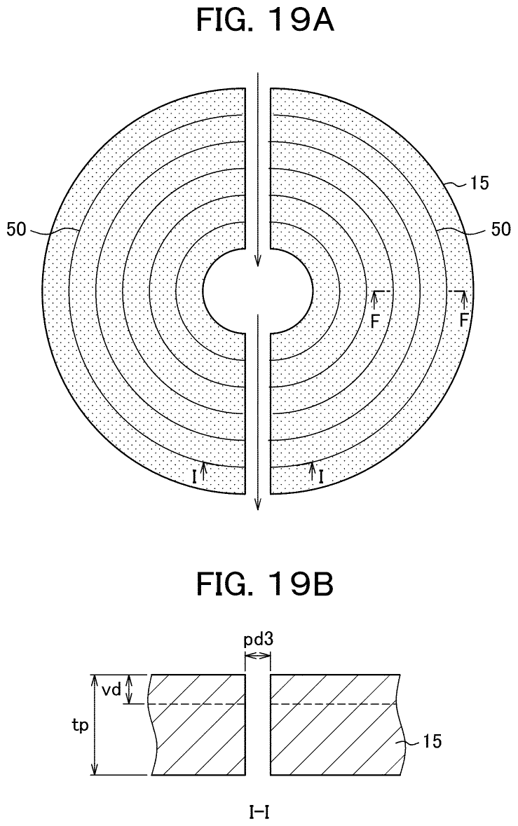

FIG. 18A is a plan view of the prism sheet 15 according to embodiment 2. In FIG. 18A, a prism array 50 is formed concentrically. A cross sectional view of the prism array 50 along the line F-F is the same as FIG. 11B. The feature of FIG. 18A is that the circular prism is not continuous, but it is formed in discrete, in other words, the prism circle has discontinuous regions in arbitrary interval circumferentially. In FIG. 18A, arrows in broken lines are paths for air. Even the direction of the arrows of broken lines is downward in FIG. 18A, it can be either upward or downward.

FIG. 18B is a cross sectional view of FIG. 18A along the line H-H, which is a cross sectional view of the discontinuous part. A depth vd indicated by broken line in FIG. 18B is a depth vd of the V groove of the prism array 50 shown in FIG. 11B. The discontinuous part 52 in FIG. 18B simply shows that a projection of the prism of the prism array 50 does not exist at this part. The cross sectional view of the discontinuous part 52 in FIG. 18B is rectangle, however, the cross section of the groove can be V shaped, as depicted in FIG. 18C, U shaped or semicircular shaped. In addition, a length pd2 of the discontinuous part 52 in circumferential direction is preferably the same as a pitch pp of the prism array 50 or more to release air easily.

### Embodiment 3

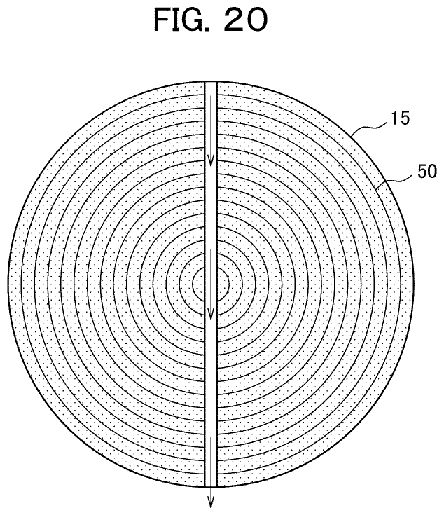

FIG. 19A is a plan view of the prism sheet 15 according to embodiment 3. In FIG. 19A, a prism array 50 is formed concentrically. A cross sectional view of the prism array 50 along the line F-F is the same as FIG. 11B. The feature of FIG. 19A is that one prism sheet is formed from separated two parts of a first prism sheet and a second prism sheet. A space is formed between the two prism sheets, which is a groove for air release. Even the direction of the arrows of broken lines, which show a release direction of the air, is downward in FIG. 19A, it can be either upward or downward. In addition, a width pd3 between the two prism sheets is preferably the same as a pitch pp of the prism array 50 or more to release air easily.

FIG. 19B is a cross sectional view of FIG. 19A along the line I-I, which shows the prism sheet 15 consists of the first prism sheet and the second prism sheet. The depth vd shown by broken line in FIG. 19B is a depth vd of the V groove of the prism array in FIG. 11B. Each of the sheets of the prism sheet 15 shown in FIGS. 19A and 19B are adhered respectively to the major surface of the light guide in separation.

The circular prism sheets 15 explained above have a hollow circle at a center. However, the present invention is applicable to the circular prism sheet which does not have a hollow circle at the center. FIG. 20 is a plan view of this prism sheet. In FIG. 20, the air path groove 51 is formed diametrically.

The air entrained in the prism array 50 is exhausted through the air path groove 51 as depicted by arrows. FIG. 20 is an example relating to embodiment 1; however, it is the same for the structures of embodiment 2 and embodiment 3.

The lighting device using the above explained prism sheet 15 can emits light of a small light distribution angle, e.g. approximately 12 degrees. In the meantime, the prism sheets explained above are applicable not only to the lighting device shown FIG. 5 or 6 but also applicable to other various lighting devices.

In the above explanation, the prism sheet has a concentric prism array; however, the present invention is also applicable to the prism array which has concentric ellipses because the closed areas are also formed in the V grooves between the elliptical prisms in this structure, too. In this structure, which uses a prism array of the concentric ellipses, however, the lighting device has different light converging effects between the cross section along the major axis and the miner axis of the ellipse.

What is claimed is:

1. A prism sheet having a circular outer shape and a concentric prism array on one surface,
wherein a groove is formed in radial direction from a center of the concentric prism array as to cross the concentric prism array.

2. The prism sheet according to claim 1,
wherein the groove crosses an inner most array of the concentric prism array and an outer most array of the concentric prism array.

3. The prism sheet according to claim 1,
wherein the groove is formed continuously from a center of the concentric prism array in radial direction.

4. The prism sheet according to claim 1,
wherein a depth of the groove is deeper than a depth of the concentric prism array.

5. The prism sheet according to claim 1,
wherein another surface of the prism sheet is plane.

6. A prism sheet having a circular outer shape and a concentric prism array on one surface,
wherein each of circular prisms which constitutes the concentric prism array has a discontinuous part in circumferential direction.

7. The prism sheet according to claim 6,
wherein a plurality of the discontinuous parts are formed in one circle of the prism array.

8. The prism sheet according to claim 6,
wherein the discontinuous part is formed in all the circles of the concentric prism array.

9. The prism sheet according to claim 6,
wherein another surface of the prism sheet is plane.

10. A prism sheet having a circular outer shape comprising:
a semicircular first prism sheet and a semicircular second prism sheet,
wherein a first prism array which has a plurality of concentric semicircular array is formed on one surface of the first prism sheet,
a second prism array which has another plurality of concentric semicircular array is formed on one surface of the second prism sheet, and
the first prism sheet and the second prism sheet are disposed with a predetermined distance therebetween.

11. The prism sheet according to claim 10,
wherein the predetermined distance is the same or more compared with a pitch of the first prism array and the second prism array.

12. The prism sheet according to claim 10,
wherein another surface of the first prism sheet is plane, and another surface of the second prism sheet is plane.
